(19) United States
(12) Patent Application Publication
(10) Pub. No.: US 2009/0257676 A1
(43) Pub. Date: Oct. 15, 2009

(54) SYSTEMS AND METHODS FOR PICTURE EDGE ENHANCEMENT

(76) Inventor: Masafumi Naka, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/099,934

(22) Filed: Apr. 9, 2008

(51) Int. Cl. G06K 9/40

(52) U.S. Cl. 382/264; 382/266

(57) ABSTRACT

Systems and methods for effectively and naturally enhancing the relative contrast between an image object and the surrounding background image in television pictures. In one embodiment, a television system preferably comprises a central processing unit (CPU) coupled to an audio-video output unit. The CPU preferably comprises non-volatile memory coupled to a logic unit which is adapted to receive and process a program signal S_{P} and output an enhanced program signal S_{EP} to the audio-video output unit. The logic unit preferably includes a differential waveform generator in one embodiment and a low pass filter in another embodiment. In operation in one embodiment, a waveform comprising a second differential of an original waveform and an inverted copy of the second differential of the original waveform is low pass filtered, and, depending on the shape of the original waveform, inverted prior to adding it to the original waveform to generate an enhanced waveform with improved relative contrast. In operation in an alternative embodiment, an aperture waveform is generated by adding a low pass filtered and inverted waveform of an original waveform to the original waveform, and then added to the original waveform to generate an enhanced waveform with improved relative contrast.

### FIELD

The present invention relates generally to televisions and, more particularly, to systems and methods that facilitate enhancement of the relative contrast between an image object and the surrounding background image.

### BACKGROUND

Television pictures are subject to variations in quality due to improper television picture settings and/or less than ideal or inconsistent production, signal processing and transmission conditions. The quality or sharpness of a television picture can be improved by enhancing the relative contrast of an image object and the surrounding background image. FIG. 1A shows an image object and surrounding background without any enhancement. Conventional techniques typically include modifying the waveform of the picture signal with a rectangular waveform positioned at the edge of the image object resulting in an enhanced picture as shown in FIG. 1B. However, the resulting enhancement observed at the edge of the image object tends to appear artificial or non-natural and tends not to improve the relative contrast between the image object and the surrounding background image.

Therefore, it would be desirable to provide systems and methods that facilitate natural looking enhancement of the relative contrast between an image object and the surrounding background image.

### SUMMARY

Embodiments described herein are directed to improved methods and systems for effectively and naturally enhancing the relative contrast between an image object and the surrounding background image in television pictures. The enhanced picture includes a smooth and/or gradual transition from low to high contrast in the contrast transition region along the edge of the image object, which enhances the relative contrast between the image object and background image of the picture.

In one embodiment, a television system adapted to enhance the relative contrast between image objects and backgrounds images of a television picture through edge enhancement preferably comprises a central processing unit (CPU) coupled to an audio-video output unit. The CPU preferably comprises non-volatile memory coupled to a logic unit which is adapted to receive and process a program signal S_{P} and output an enhanced program signal S_{EP} to the audio-video output unit. The logic unit preferably includes an object edge detection circuit adapted to detect the edges of an object within the television picture and identify the corresponding waveform surrounding the edge of the object, a signal divider circuit coupled to the object edge detection circuit, and a differential waveform generator circuit coupled to the signal divider circuit and adapted to generate, depending on the original waveform associated with the detected object image edge, a negative or positive waveform surrounding the edge of the object. The logic unit further includes a signal adder circuit coupled to the differential waveform generator circuit and the signal divider circuit. The signal adder circuit is adapted to add the waveform generated by the differential waveform generator circuit to the program signal S_{P} to modify the waveform surrounding the edge of the object image and output the enhanced program signal S_{EP} to the audio-video output unit.

The differential waveform generator circuit preferably includes a first differential module adapted to generate a first differential waveform from the original waveform surrounding the edge of the object image and a second differential module coupled to the first differential module and adapted to generate a second differential waveform. The differential waveform generator circuit further comprises a signal divider coupled to the second differential module, an inverter coupled to the signal divider and a signal adder coupled to both the inverter and the signal divider to add the second differential waveform and the inverted second differential waveform, and output the combined waveform to a positive waveform slicer module coupled to the signal adder. The positive waveform slicer module outputs a positive waveform to a low pass filter.

In operation, the program signal S_{P} is passed through the object edge detection circuit which then detects the waveform surrounding the edge of object image, i.e., the original waveform. Next, first and second differential waveforms are generated from the original waveform and the second differential waveform is added to an inverted copy of itself and then passed through a positive waveform slicer and a low pass filter. The low pass filtered waveform is added to the original waveform to form a modified or enhanced waveform surrounding the edge of the object image. The modified waveform includes a smooth and/or gradual transition from low to high contrast in a contrast transition region surrounding the edge of the object image resulting in a more natural looking image.

In an alternative embodiment the logic unit preferably includes an object edge detection circuit, a signal divider circuit coupled to the object edge detection circuit, a low pass filter coupled to the signal divider circuit, an inverter coupled to the low pass filter and a first signal adder circuit coupled to the inverter and the signal divider circuit. The logic unit further includes a second signal adder circuit coupled to the first signal adder circuit and the signal divider circuit.

In operation, the program signal S_{P} is passed through the object edge detection circuit which then detects the waveform surrounding the edge of object image, i.e., the original waveform. Next, the original waveform is passed through a low pass filter to generate a low pass filtered waveform which is then inverted and added to the original waveform to generate a waveform of an aperture image. Next, the aperture image waveform is added to the original waveform to form a modified or enhanced waveform corresponding to an improved image with aperture. The modified waveform includes a smooth and/or gradual transition from low to high contrast in a contrast transition region surrounding the edge of the object image resulting in a more natural looking image.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1A is an television picture showing an image object and surrounding background image without any edge enhancement.

FIG. 1B is the television picture of FIG. 1A showing an image object and surrounding background image with convention edge enhancement.

FIG. 1C is the television picture of FIG. 1A showing an image object and surrounding background image with edge enhancement in accordance with the embodiments described herein.

FIG. 2 is a schematic diagram of a television system.

FIG. 3 is a schematic diagram of an embodiment of the logic unit of the television system shown in FIG. 2.

FIG. 4 is a process diagram depicting a method for enhancement of relative contrast of an image object and the background image of a television picture.

FIGS. 5A through 5G are diagrams depicting the waveforms detected and generated in the steps of the method depicted in FIG. 4.

FIG. 6 is a schematic diagram of an embodiment of the logic unit of the television system shown in FIG. 2.

FIG. 7 is a process diagram depicting a method for enhancement of the relative contrast of an image object and the background image of a television picture.

FIGS. 8A through F are diagrams depicting the waveforms detected and generated in the steps of the method depicted in FIG. 7.

FIG. 9 is a diagram depicting the process of enhancing a television picture.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

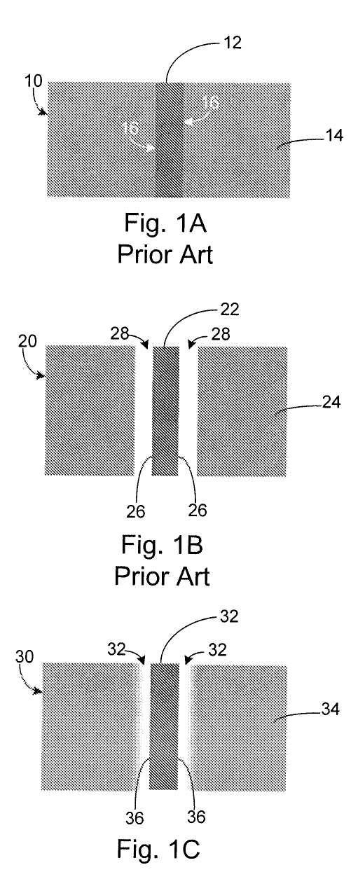

Embodiments described herein are directed to improved methods and systems for effectively and naturally enhancing the relative contrast between an image object and the surrounding background image in television pictures. FIG. 1A shows a television picture 10 comprising a dark band 12 symbolizing an image object and a lighter region 14 symbolizing the background image surrounding the image object 12. As depicted, the television picture 10 does not include any enhancement to improve the relative contrast between the background image 14 and the image object 12 about the edges 16 of the image object 12. FIG. 1B shows the same television picture 20 having a dark band 22 symbolizing an image object and a lighter region 24 symbolizing the background image of the picture 20. However, in FIG. 1B, the picture 20 is enhanced in accordance with conventional methods by modifying the corresponding waveform with rectangular waveforms along the edges 26 of the image object 22. As a result, the enhancement to the picture 20 appears unnatural with bright regions 28 formed between the background image 24 and the image object 22. FIG. 1C, however, shows the same television picture 30 enhanced by processing the corresponding waveform in accordance with the embodiments described herein. As depicted, FIG. 1C includes a dark band 32 symbolizing an image object and a lighter region 34 symbolizing the background image of the picture 30 with a contrast transition region 38 between the image object 32 and background image 34 about the edges 36 of the image object 32. Because of the smooth and/or gradual transition from low to high contrast in the contrast transition region 38 along the edge of the image object 32, the image object 32 of FIG. 1C, although lighter than the image objects 12 and 22 of FIGS. 1A and 1B, appears to be darker than the image objects 12 and 22 of FIGS. 1A and 1B due to the enhanced the relative contrast between the image object 32 and background image 34 of the picture 30.

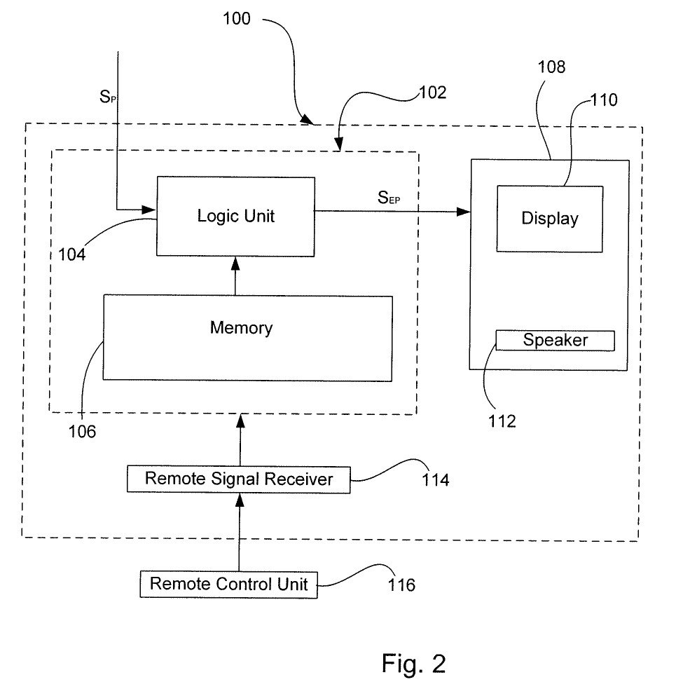

Turning to FIGS. 2-9, the embodiments provided herein are described in detail. In one embodiment, as depicted in FIG. 2, a television system 100 adapted to enhance the relative contrast between image objects and backgrounds images of a television picture through edge enhancement preferably comprises a central processing unit (CPU) 102 coupled to an audio-video output unit 108 and a remote signal receiver 114, which is operably coupled to a remote control unit 116. The CPU 102 preferably comprises non-volatile memory 106 coupled to a logic unit 104 which is adapted to receive and process a program signal S_{P} and output an enhanced program signal S_{EP} to the audio-video output unit 108. The audio-video output unit 108 preferably includes a video display 110 for displaying the television picture or video component of the enhanced program signal S_{EP} and a speaker 112 for outputting the audio component of the enhanced program signal S_{EP} associated with the video component of enhanced program signal S_{EP}.

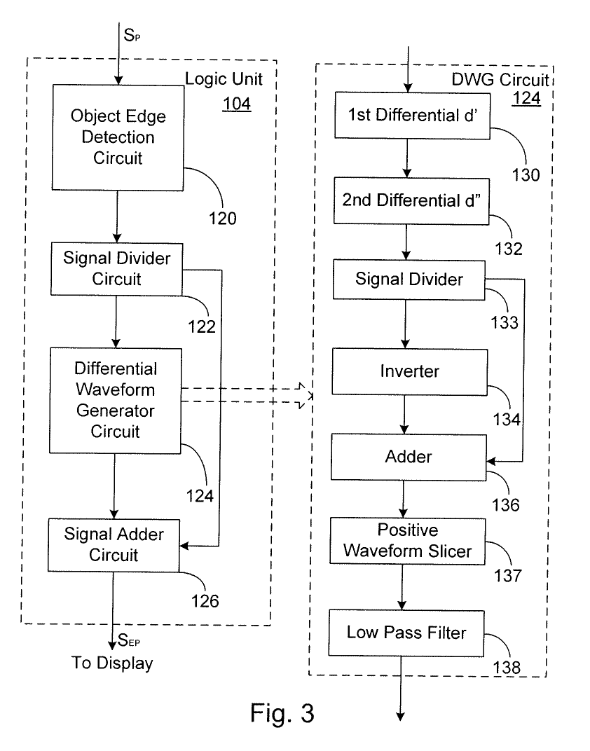

As depicted in FIG. 3, the logic unit 104 preferably includes an object edge detection circuit 120 adapted to detect the edges of an object within the television picture and identify the corresponding waveform surrounding the edge of the object, a signal divider circuit 122 coupled to the object edge detection circuit 120, and a differential waveform generator circuit 124 coupled to the signal divider circuit and adapted to generate, depending on the original waveform associated with the detected object image edge, a negative or positive waveform surrounding the edge of the object. The logic unit further includes a signal adder circuit 126 coupled to the differential waveform generator circuit 124 and the signal divider circuit 122. The signal adder circuit 126 is adapted to add the waveform generated by the differential waveform generator circuit 124 to the program signal S_{P} to modify the waveform surrounding the edge of the object image and output the enhanced program signal S_{EP} to the audio-video output unit 108.

The differential waveform generator circuit 124 preferably includes a first differential module 130 adapted to generate a first differential (d′) waveform from the original waveform surrounding the edge of the object image and a second differential module 132 coupled to the first differential module and adapted to generate a second differential (d″) waveform of the original waveform surrounding the edge of the object image from the first differential (d′) waveform. The differential waveform generator circuit 124 further comprises a signal divider 133 coupled to the second differential module 132, an inverter 134 coupled to the signal divider 133 and a signal adder 136 coupled to both the inverter 134 and the signal divider 133 to add the second differential (d″) waveform and the inverted second differential (−d″) waveform, and output the combined waveform (d″+(−d″) to a low pass filter 138 coupled to the signal adder 136.

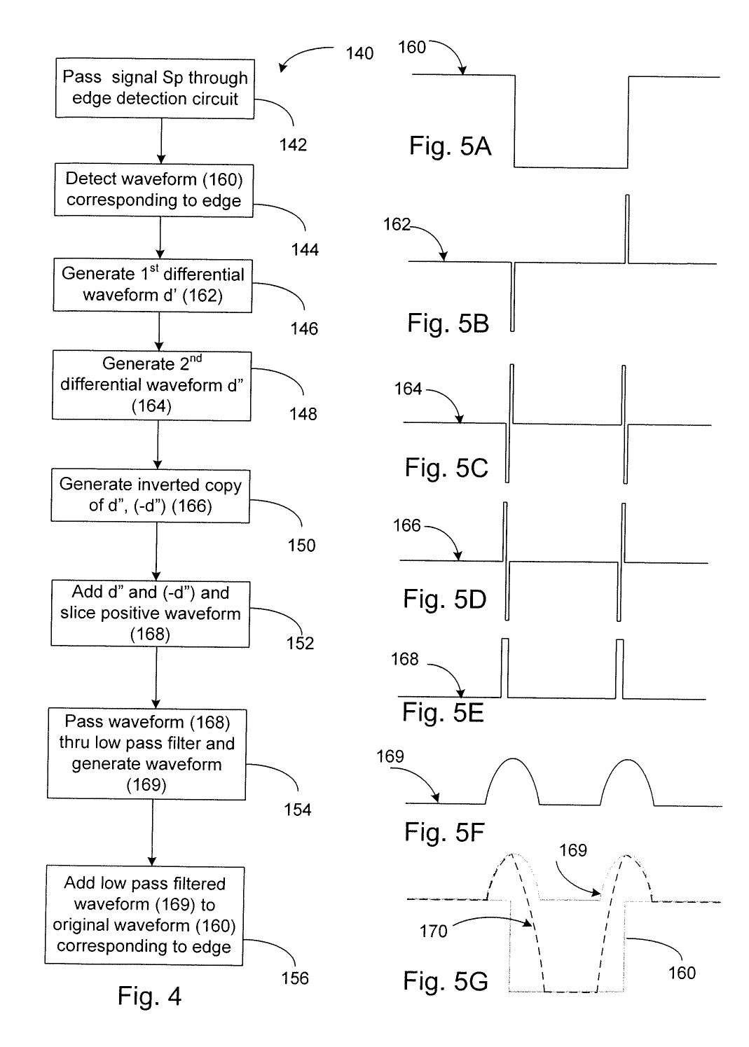

In operation, a process 140 depicted in FIG. 4 is used to generate an enhance program signal S_{EP} having a waveform 170 shown in FIG. 5F. Turning to FIG. 4, the program signal S_{P} is passed through the object edge detection circuit (120, FIG. 3) at step 142, which then, at step 144, detects the waveform surrounding the edge of object image, i.e., the original waveform 160 shown in FIG. 5A. Next, at step 146, a first differential, d′, waveform 162 (FIG. 5B) is generated from the original waveform 160. At step 148, a second differential, d″, waveform 164 (FIG. 5C) of the original waveform 160 is generated from the first differential, d′, waveform 162. An inverted copy of the second differential, −d″, waveform 166 is generated at step 150. At step 152, the second differential waveforms 164 and 166 are added together and then sliced to form a combined positive waveform 168 shown in FIG. 5D. The positive waveform 168 is passed through a low pass filter at step 154 to form a low filtered waveform 169 shown in FIG. 5F. At step 156, the low pass filtered waveform 169 is added to the original waveform to form a modified or enhanced waveform 170 (FIG. 5G) surrounding the edge of the object image. The modified waveform 170 includes a smooth and/or gradual transition from low to high contrast in a contrast transition region surrounding the edge of the object image resulting in a more natural looking image such as that shown in FIG. 1C.

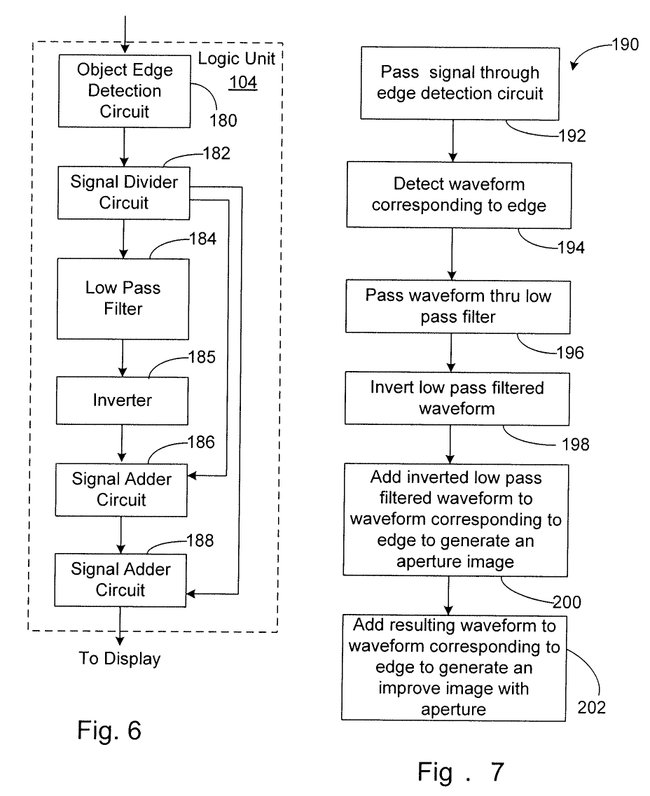

In an alternative embodiment shown in FIG. 6, the logic unit 104 preferably includes an object edge detection circuit 180 adapted to detect the edges of an object within the television picture and identify the corresponding waveform surrounding the edge of the object, a signal divider circuit 182 coupled to the object edge detection circuit 180, a low pass filter 184 coupled to the signal divider circuit 182 and adapted to generate a low pass filtered waveform, an inverter 185 coupled to the low pass filter 184 and a first signal adder circuit 186 coupled to the inverter 185 and the signal divider circuit 182 and adapted to add the waveform generated by the low pass filter 184 and inverted by the inverter 185 to the program signal S_{P} output from the signal divider circuit 182 to generate a waveform corresponding to an aperture image. The logic unit 104 further includes a second signal adder circuit 188 coupled to the first signal adder circuit 186 and the signal divider circuit 182 and adapted to add the waveform corresponding to the aperture image and generated the first signal adder circuit 186 to the program signal S_{P} output from the output from the signal divider circuit 182 to modify the waveform surrounding the edge of the object image and output the enhanced program signal S_{EP} containing an improved image with aperture to the audio-video output unit 108.

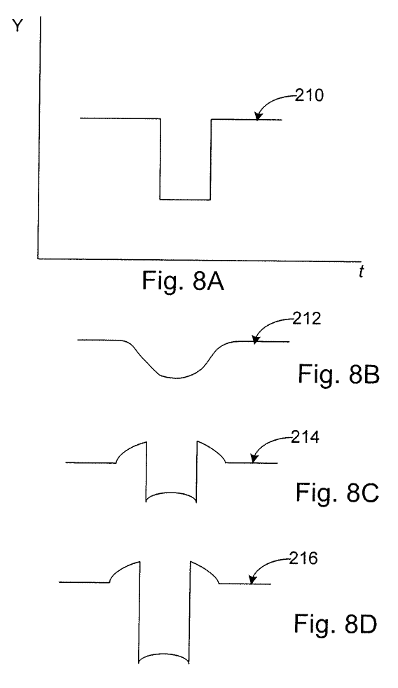

In operation, a process 190 depicted in FIG. 7 is used to generate an enhance program signal S_{EP} having a waveform 216 shown in FIG. 8D. Turning to FIG. 7, the program signal S_{P} is passed through the object edge detection circuit (180, FIG. 6) at step 182, which then, at step 194, detects the waveform surrounding the edge of object image, i.e., the original waveform 210 shown in FIG. 8A. Next, at step 196, the original waveform 210 is passed through a low pass filter to generate a low pass filtered waveform 212 shown in FIG. 8B. At step 198, the low pass filtered waveform 212 is inverted and added to the original waveform 210 at step 200 to generate a waveform 214 (FIG. 8C) of an aperture image. Next, at step 202, the aperture image waveform 214 shown in FIG. 8C is added to the original waveform 210 to form a modified or enhanced waveform 216 (FIG. 8D) corresponding to an improved image with aperture. The modified waveform 216 includes a smooth and/or gradual transition from low to high contrast in a contrast transition region surrounding the edge of the object image resulting in a more natural looking image such as that shown in FIG. 1C.

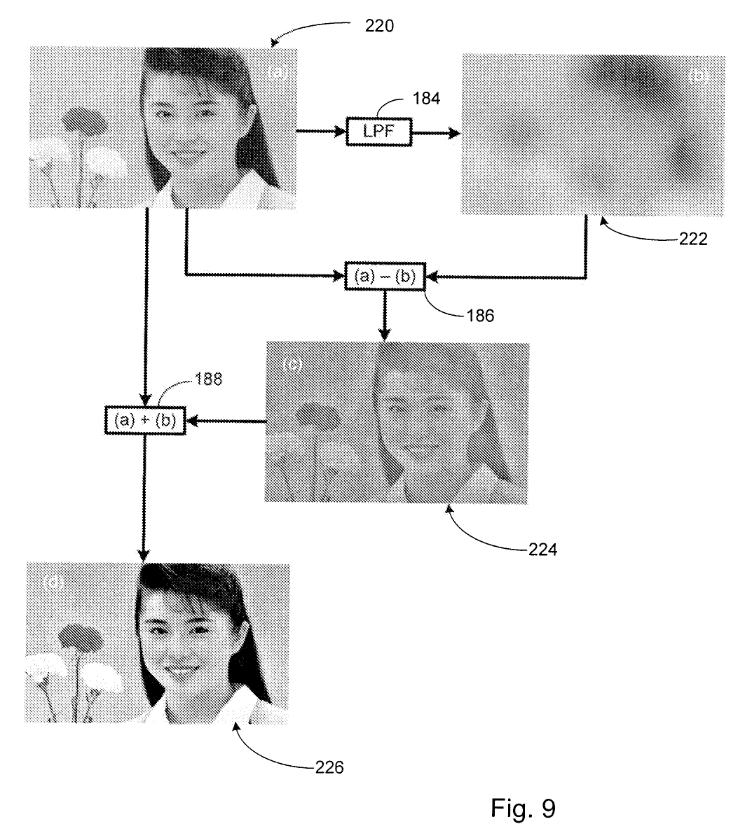

Turning to FIG. 9, the process described and illustrated with regard to FIGS. 6-8D is illustrated using a non-enhanced television picture 220. The picture 220 is passed through a low pass filter 184 to generate a low pass filtered image 222. The low pass filtered image 222 is then inverted and added to the non-enhanced television picture 220 by a signal adder 186 to generate an aperture image 224. The aperture image 224 is then added to the non-enhanced television picture 220 by another signal adder 188 to form an improved image with aperture 226.

As one of ordinary skill in the art would readily recognize the circuits, adders, inverters, and modules referred to herein can be any number of forms of programmable including, but limited to, a circuit within a circuit board, a processor chip, a circuit within a processor chip, software comprising a series of instructions stored in memory and executable on a processor, and the like.

The particular examples set forth herein are instructional and should not be interpreted as limitations on the applications to which those of ordinary skill are able to apply the systems and methods described herein. Modifications and other uses are available to those skilled in the art which are encompassed within the spirit of the invention as defined by the scope of the appended claims.

What is claimed is:

1. A television system adapted to enhance the relative contrast between image objects and backgrounds images of a television picture through edge enhancement comprising
an audio-video output unit, and
a central processing unit (CPU) coupled to the audio-video output unit, the CPU comprising,
non-volatile memory, and
a logic unit coupled which is configured to receive and process a program signal by providing a gradual transition from low to high contrast in a contrast transition region along an edge of an object image enhancing the relative contrast between the object image and a surrounding background image of a picture in the program signal.

2. The television system of claim 1 wherein the login unit comprises
an object edge detection circuit adapted to detect the edges of an object image within a picture in a program signal and identify a corresponding object edge waveform surrounding the edge of the object image,
a signal divider circuit coupled to the object edge detection circuit,
a differential waveform generator circuit coupled to the signal divider circuit, and
a signal adder circuit coupled to the differential waveform generator circuit and the signal divider circuit to add the waveform generated by the differential waveform generator circuit to the object edge waveform surrounding the edge of the object image and output an enhanced object edge waveform.

3. The television system of claim 2 wherein the differential waveform generator circuit comprises
a first differential module adapted to generate a first differential waveform from the object edge waveform surrounding the edge of the object image, and
a second differential module coupled to the first differential module and adapted to generate a second differential waveform from the first differential waveform.

4. The television system of claim 3 wherein the differential waveform generator circuit further comprises
a signal divider coupled to the second differential module,
an inverter coupled to the signal divider, and
a signal adder coupled to both the inverter and the signal divider to add the second differential waveform and the inverted second differential waveform.

5. The television system of claim 4 wherein the differential waveform generator circuit further comprises a positive waveform slicer coupled to the signal adder and a low pass filter coupled to the waveform slicer.

6. The television system of claim 1 wherein the login unit comprises
an object edge detection circuit adapted to detect the edges of an object image within a picture in a program signal and identify a corresponding object edge waveform surrounding the edge of the object image,
a signal divider circuit coupled to the object edge detection circuit,
a low pass filter coupled to the signal divider circuit,
an inverter coupled to the low pass filter,
a first signal adder circuit coupled to the inverter and the signal divider circuit, and
a second signal adder circuit coupled to the first signal adder circuit and the signal divider circuit.

7. A method for enhancing the relative contrast between image objects and backgrounds images of a television picture through edge enhancement comprising the steps of
receiving a program signal
detecting a object edge waveform surrounding an edge of an object image in a television picture in the program signal, and
modifying the object edge waveform to include a gradual transition from low to high contrast in a contrast transition region surrounding the edge of the object image.

8. The method of claim 7 wherein the step of modifying the object edge waveform comprises the steps of
generating a first differential waveform from the object edge waveform,
generating a second differential waveform from the first differential waveform,
combining the second differential waveform to an inverted copy of itself to form a combined second differential waveform and slicing the second differential waveform to capture a positive second differential waveform,
low pass filtering the positive second differential waveform to generate a low pass filtered waveform, and
combining the low pass filtered waveform with the object edge waveform to form an enhanced object edge waveform surrounding the edge of the object image.

8. The method of claim 7 wherein the step of modifying the object edge waveform comprises the steps of
low pass filtering the object edge waveform is passed through a low pass filter to generate a low pass filtered waveform,
inverting low pass filtered waveform,
combining the inverted low pass filtered waveform with the object edge waveform to generate an aperture image waveform, and
combining the aperture image waveform with the object image waveform to form a an enhanced waveform corresponding to an improved image with aperture.
